(19) United States
(12) Patent Application Publication
(10) Pub. No.: US 2023/0154317 A1
(43) Pub. Date: May 18, 2023

(54) METHOD FOR CONTROLLING A MOBILITY SYSTEM, DATA PROCESSING DEVICE, COMPUTER-READABLE MEDIUM, AND SYSTEM FOR CONTROLLING A MOBILITY SYSTEM

(71) Applicant: Volvo Car Corporation, Gothenburg (SE)

(72) Inventors: Johan Amoruso Wennerby, Göteborg (SE); Martin Ivarson, Göteborg (SE); Fabien Batejat, Göteborg (SE)

(21) Appl. No.: 18/056,457

(22) Filed: Nov. 17, 2022

(30) Foreign Application Priority Data
Nov. 18, 2021 (WO) 21209078.1

(51) Int. Cl. G08G 1/01; G08G 1/052

(52) U.S. Cl. CPC G08G 1/0145; G08G 1/0112; G08G 1/0129; G08G 1/0133; G08G 1/052

(57) ABSTRACT

The disclosure relates to a method for controlling a mobility system. The mobility system comprises a roadway infrastructure and a plurality of participants being able to travel within the roadway infrastructure. The method comprises providing a representation of the roadway infrastructure. In the representation, a road segment is described by at least one road segment attribute or a travel path is described by at least one travel path attribute. Moreover, at least one travel experience parameter is received from at least one of the plurality of participants or at least one infrastructure experience parameter is received from at least one element of the roadway infrastructure. Subsequently, at least one of the road segment attribute or the travel path attribute is amended such that an influence of the above parameters is reflected. Moreover, a corresponding data processing device is presented. Additionally, a computer-readable medium and a system for controlling the mobility system are explained.

### CROSS-REFERENCE TO RELATED APPLICATIONS

This application claims the benefit of and priority to pending EP patent application serial number 21209078.1, filed Nov. 18, 2021 and entitled “METHOD FOR CONTROLLING A MOBILITY SYSTEM, DATA PROCESSING DEVICE, COMPUTERREADABLE MEDIUM, AND SYSTEM FOR CONTROLLING A MOBILITY SYSTEM,” the entirety of which is hereby incorporated by reference herein.

### TECHNICAL FIELD

The present disclosure relates to a method for controlling a mobility system, the mobility system comprising a roadway infrastructure and a plurality of participants being able to travel within the roadway infrastructure.

Furthermore, the disclosure is directed to a data processing device comprising means for carrying out the above method.

Moreover, the disclosure relates to a computer-readable medium comprising instructions which, when executed by a computer, cause the computer to carry out the above method.

Additionally, the disclosure is directed to a system for controlling a mobility system.

### BACKGROUND

Mobility systems can be controlled on a participant-level which can also be designated a device-level or agent-level. In this case, each participant executes control functionalities, wherein it is also possible to take into account the presence and/or properties of other participants. Such control functionalities can rely on the communication of control parameters between participants, so-called participant-to-participant communication.

The participants of the mobility system include for example vehicles.

### SUMMARY

It is an objective of the present disclosure to improve the control of a mobility system. Especially, the control of the mobility system shall be improved in respect of operational safety and operational efficiency.

The problem is at least partially solved or alleviated by the subject matter of the independent claims of the present disclosure, wherein further examples are incorporated in the dependent claims.

According to a first aspect, there is provided a method for controlling a mobility system, the mobility system comprising a roadway infrastructure and a plurality of participants being able to travel within the roadway infrastructure, comprising:
providing a representation of the roadway infrastructure in the form of a graph having a plurality of nodes and a plurality of edges, each of the edges connecting two out of the plurality of nodes, wherein each of the nodes represents a road segments of the roadway infrastructure and each of the edges represents a travel path, and wherein each of the road segments is described by at least one road segment attribute of the corresponding node and each of the travel paths is described by at least one travel path attribute of the corresponding edge,
receiving at least one travel experience parameter from at least one of the plurality of participants, the travel experience parameter describing directly or indirectly a travel route within the roadway infrastructure having been traveled by the participant or currently being travelled by the participant, and/or receiving at least one infrastructure experience parameter from an element of the roadway infrastructure, and
determining an influence of the travel experience parameter and/or the infrastructure experience parameter on at least one of the road segment attribute or the travel path attribute and amending the at least one of the road segment attribute and the travel path attribute such that the influence of the at least one travel experience parameter and/or the infrastructure experience parameter is reflected in at least one of an amended road segment attribute or an amended travel path attribute.

In the present context, the roadway infrastructure can alternatively be called a road network. The representation of the roadway infrastructure or the road network may be stored in a data processing device, e.g. a computer. Such a representation can be designated a digital twin.

The participants of the mobility system is any entity being able to travel within the roadway infrastructure. The participants can be motorized or non-motorized. For example, the participants of the mobility system can include at least one of a vehicle, a pedestrian or a cyclist.

In the representation, the nodes of the graph describe road segments, i.e. static aspects of the roadway infrastructure. The edges of the graph describe movements between the road segments, thus, each edge describes a journey from one road segment to another road segment. Consequently, both static and dynamic aspects of the roadway infrastructure can be represented. In this context, a graph is an efficient way for representing a roadway infrastructure in a memory of a data processing device, e.g. a computer or control unit. The at least one road segment attribute or the at least one travel path attribute allow for representing details of the roadway infrastructure.

The graph may be stored in a graph database.

In an example, the graph may be a cluster graph. This provides the advantage that patterns between different types of data or different types of attributes can be identified efficiently.

The travel experience parameter is to be understood as an alphanumeric value describing a traveling activity within the real roadway infrastructure. In this context, the participant may be seen as a sensor and the travel experience parameter may be considered a sensor value which is detected by the sensor. If the travel experience parameters of a plurality of participants are used, the acquisition of these parameters can be designated crowdsourcing. Alternatively or additionally, the travel experience parameter may comprise information relating to at least one of a type of vehicle, e.g. electric vehicle, a size of the vehicle, a drive mode used in the vehicle or historic travel date of the vehicle.

Also the infrastructure experience parameter is to be understood as an alphanumeric value. In the present context, an element of the roadway infrastructure can be seen as a sensor and the infrastructure experience parameter can be seen as a sensor value being provided by the respective infrastructure element. If more than one infrastructure element provides infrastructure experience parameters, also these parameters can be considered to be crowdsourced. Exemplary infrastructure elements being able to provide infrastructure experience parameters may include a weather station being able to provide information about current weather conditions, a base station of a mobile communication network being able to provide information about a number of communication devices being located in its field of detection, a ticketing system of a public transport means being able to provide an information about a number of tickets being purchased during a predefined time range, a parking sensor being able to provide an information about its operational state, i.e. occupied or not, or a ticketing system of an event location being able to provide an information about a number of persons entering the event location. An event location is for example a football stadium, a theater, a concert hall or a multi-purpose hall.

By determining an influence of the travel experience parameter on at least one of the road segment attribute at the travel path attribute and by amending the at least one of the road segment attribute or the travel path attribute accordingly, the representation of the roadway infrastructure is kept up-to-date and accurate. In doing so, a representation error, i.e. differences between the real roadway infrastructure and its representation, is reduced. In other words and again considering the participant to be a sensor, the representation of the roadway infrastructure is fed by sensor values. This leads to a representation with high precision and actuality.

The basic idea underlying the present disclosure has two aspects.

The first aspect comprises representing the roadway infrastructure of the mobility system using a graph. In this graph the nodes represent road segments of the roadway infrastructure. The edges of the graph represent travel paths between the road segments. This type of representation has the advantage that movements and corresponding parameters, i.e. parameters characterizing the movement, can be represented within the graph. In other words, each edge of the graph describes a journey from one road segment being represented by a node delimiting the edge to another road segment being represented by another node delimiting the edge. Consequently, information relating to the movement between road segments can be stored in the graph in an efficient manner. Moreover, such data can be retrieved and processed in a computationally efficient manner. The possibility to efficiently process the data is advantageous if optimization methods are to be used which use such data as input parameters.

It is noted that a representation by a graph can be changed dynamically. Since the roadway infrastructure of the mobility system is represented by the graph, it is possible to reflect changes in the roadway infrastructure therein. Thus, when using optimization methods, changes in the infrastructure can be taken into account and used as a control measure for the mobility system, e.g. the switching of traffic lights or the deployment of speed bumps.

Moreover, this makes it possible to adapt the infrastructure in a way that selected participants can enjoy prioritized travel, e.g. emergency vehicles. This concept can also be extended to environmentally friendly participants or participants fulfilling different, predefined criteria.

In other words, regulations of the mobility system can be imposed in a dynamic way.

The second aspect relates to the fact that the participants forming part of the mobility system acquire and provide travel experience parameters. The same applies to elements of the roadway infrastructure being able to acquire and provide infrastructure experience parameters. These parameters describe real situations of the participants and the infrastructure respectively. The travel experience parameters and the infrastructure experience parameters can be acquired and provided in real time. The parameters are used to improve the representation of the roadway infrastructure. Generally speaking, the travel experience parameters are acquired on the participant-level or device-level and then aggregated on a system-level. The same is true for the infrastructure experience parameters. Subsequently, the improved representation can be at least partially provided to the participants and/or elements of the roadway infrastructure. Generally speaking, the improved representation can be provided to any type of an external entity. In this context, an external entity can be understood as any entity that is external to the entity comprising the improved representation. This means that insights gained on the system-level can be provided to the participant-level or, more generally speaking, to the external entity. Moreover, on the system-level the representation and the travel experience parameters can be used for running data analysis and optimizations. The results thereof can be provided to the participants as travel objective parameters or to the elements of the roadway infrastructure as infrastructure objective parameters. In other words, insights generated on system-level are provided to the participant-level or the infrastructure. Consequently, a closed control loop can be provided between the system-level and the participant-level and/or infrastructure-level. In other words, a so-called plan-do-check-act-cycle can be established at the level of the mobility system.

The disclosure is especially directed to mobility systems comprising autonomous or partially autonomous vehicles. The above-mentioned effects are particularly advantageous in such systems since the efficient storage and processing of data relating to movements can easily be performed by standard control units of autonomous or partially autonomous vehicles.

According to an example, the method comprises providing the at least one of the amended road segment attribute or the amended travel path attribute to an external entity or deriving at least one travel objective parameter from the at least one of the amended road segment attribute or the amended travel path attribute and providing the travel objective parameter to the external entity. Again, the external entity is to be understood as an entity external to the one comprising the amended road segment attribute or the amended travel path attribute or the travel objective parameter.

In this example, the method covers two alternatives. In the first alternative at least one of the amended road segment attribute or the amended travel path attribute is provided to the external entity. This means that the external entity disposes of an improved representation of the roadway infrastructure. Consequently, the external entity can take for example better traveling decisions. Thus, the operational safety and efficiency of the external entity is improved.

If the external entity is an autonomous vehicle, the traveling decisions can be taken autonomously and if the external entity is a vehicle driven by a human driver, the human driver can be assisted in taking better traveling decisions.

In the second alternative, a travel objective parameter is derived from the at least one of the amended road segment attribute or the amended travel path attribute. The travel objective parameter is provided to the external entity. The travel objective parameter for example comprises an instruction on how to travel. Also in this alternative operational safety and efficiency of the external entity are improved.

The amended travel path attribute, the amended road segment attribute and/or the travel objective parameter can be provided to the external entity via a data push or a data pull.

In an example, the method is at least partially performed periodically. Consequently, the representation of the roadway infrastructure is periodically updated and adapted to the conditions in the real roadway infrastructure.

The external entity may be at least one of a traffic monitoring system, at least one of the plurality of participants, a cloud service or an external unit. Again, the external entity is to be understood as an entity being external to the entity providing the relevant information or data. Thus, the insights as explained above can be used within the mobility system on a participant level and on a system level. Moreover, a use outside the mobility system is possible. More generally, the insights revealed in any portion of the mobility system can be used in any other portion thereof or even outside the mobility system. The travel objective parameter may for example be communicated to an emergency coordination center being an external unit. In this context, the travel objective parameter may comprise the information about an accident that has already happened or information about a high accident risk. In the latter case, corresponding emergency vehicles may already be prepared.

In an example, providing the travel objective parameter may comprise applying at least one of a pattern recognition technique, a statistical analysis, or a machine learning technique to at least one of the amended road segment attribute or the amended travel path attribute. It is of course possible to apply the at least one of a pattern recognition technique, a statistical analysis or a machine learning technique to a plurality of amended road segment attributes and/or a plurality of amended travel path attributes. Also, the at least one of a pattern recognition technique, a statistical analysis or a machine learning technique can be applied to all available amended road segment attributes and/or all available amended travel path attributes. In doing so, patterns, statistical relations and/or correlations can be detected which provide insights into the mobility system. These insights are then transformed into the travel objective parameter. Consequently, the participants of the mobility system can take into account these insights when travelling within the roadway infrastructure.

In general, the at least one of a pattern recognition technique, a statistical analysis or a machine learning technique being applied to a graph can be designated a graph analytics technique.

Using the at least one of a pattern recognition technique, a statistical analysis or a machine learning technique can be used for making predictions about a future state of the mobility system.

The machine learning technique comprises for example a link prediction technique or a graph embedding technique. Also a graph neural network can be used.

The travel objective parameter may comprise at least one of a warning message, a travelling behavior recommendation, a travelling behavior instruction or a travelling behavior limitation. The travel objective parameter may be adapted to be used in a participant being a fully autonomous vehicle, in a partially autonomous vehicle and in a non-autonomous vehicle, i.e. a vehicle which is fully controlled by a human driver. A warning message may comprise a warning of a slippery road, high accident risk, and incident on the road, a traffic jam etc. A traveling behavior recommendation may comprise a speed recommendation or a route recommendation. Also, a traveling behavior instruction and a traveling behavior limitation may relate to speed or a route. However, an instruction may differ from a recommendation in that the instruction cannot be overruled. A limitation may relate to an interval which is closed at one side only, i.e. a maximum speed. Independent from the specific aspects to which the travel objective parameter is directed, this parameter enhances travel security and operational efficiency of the mobility system. In an illustrative scenario, the travel objective parameter relates to a maximum speed. This reduces the risk of accidents. In an alternative scenario, the travel objective parameter may relates to a speed range guaranteeing smooth participant flow within the mobility system. If a defined speed is communicated to a plurality of participants in the form of a travel objective parameter, the speed of the individual participants can be adopted such that on a system-level and optimum participant flow is reached. This can be designated a connected cruise control.

The road segment attribute and the amended road segment attribute each may comprise at least one of an identification parameter, a location parameter, a road class parameter, a road geometry parameter, a road friction parameter, a traffic flow parameter, a traffic regulation parameter, an accident probability parameter or a hazard probability parameter. In this context, and identification parameter is an alphanumeric value being suitable for identifying the corresponding road segment. A location parameter comprises information regarding the location of the corresponding road segment. The road class parameter defines a road-class to which the corresponding road segment belongs. Exemplary road classes are highway, city roads, dirt track, sidewalk, cycle path, multiple carriageway, single carriageway, roundabout, traffic square, sliproad. A road geometry parameter characterizes the geometry of the road, e.g. in the form of a polynomial curve. A road friction parameter characterizes the friction of the corresponding road segment. The friction may vary according to weather conditions, e.g. rain and ice. The road friction parameter may be a number between 0 and 1, wherein 0 means there is no friction at all and 1 means that frictional force equals normal force. The traffic flow parameter characterizes the corresponding road segment by its capacity for traffic flow. In one example the traffic flow parameter relates to a number of lanes on the corresponding road segment. Alternatively, the traffic flow parameter may relate to a speed on the corresponding road segment or a number of participants that can travel the road segment during a predefined time unit. A traffic regulation parameter is related to a traffic regulation feature of the corresponding road segment. Such a traffic regulation feature may be a traffic light or a deployable speed bump. By amending the traffic regulation parameter, an operational state or a way of operating of the traffic regulation feature may be adapted. An accident probability parameter is a parameter characterizing the risk that an accident happens on the corresponding road segment. Analogously, a hazard probability parameter characterizes the risk that a hazard happens, e.g. an animal on the road or an object on the road. Thus, using the road segment attribute and the amended road segment attribute, the corresponding road segment can be described in the relevant aspects. This leads to an accurate and useful representation of the road segment.

The travel path attribute and the amended travel path attribute each may comprise at least one of an identification parameter, a neighbor description parameter, a travel probability parameter or an intersection angle parameter. In the present context, an identification parameter is an alphanumeric value being suitable for identifying the travel path. A neighbor description parameter is a parameter describing the nodes, i.e. the road segments, limiting the edge, i.e. the travel path. The neighbor description parameter may for example comprise the identification parameters of the adjacent road segments. The nature of a travel probability parameter can best be understood if a travel path is not the only travel path starting from an adjacent road segment. In such a case the travel probability parameter defines the probability by which the participant will take a specific one of the travel paths. Obviously, the probabilities of all travel paths starting from one road segment add up to one. Moreover, if only one travel path starts from a road segment, the corresponding travel probability is one. An intersection angle parameter characterizes an angle between 0° and 360° by which the road segments being connected by the travel path meet each other. Using at least one of the above parameters leads to an accurate and useful representation of the travel paths within a roadway infrastructure.

The travel experience parameter may comprise at least one of a position parameter or a travel speed parameter. In other words, the travel experience parameter may comprise a record of the positions that the corresponding participant had while traveling within the roadway infrastructure. Alternatively or additionally, the travel experience parameter may comprise a record of speed at which the corresponding participant was traveling within the roadway infrastructure. By providing the travel experience parameters of a plurality of participants, an overview of the positions and speed of the participants within the roadway infrastructure can be generated. Analyzing the travel experience parameters offers insights into the mobility system. For example a traffic jam can be detected in a portion of the roadway infrastructure where a lot of participants are located which do not travel at all or only travel at very low speed.

In an example, the road segment attribute and the travel path attribute are jointly analyzed for providing the travel objective parameter. This means that both information regarding the structure and information regarding the movements within the roadway infrastructure are considered for providing the travel objective parameter. For example, a road closure is a static information about the roadway infrastructure. In such a case, additional information about the movements of the participants can be considered, i.e. it can be considered which alternative route is taken by the majority of the participants. The travel objective parameter can thus, for example, point to a different alternative route. In a case where there is no further alternative, the travel objective parameter may recommend a speed which is suitable for providing fluent traffic on the alternative route, even though it is overloaded with participants.

In another example, at least one of the road segments is described by at least one historic road segment attribute. Alternatively or additionally, at least one of the travel paths is described by at least one historic travel path attribute. In this context, the historic road segment attribute relates to the same type of information as the road segment attribute which can be designated a current road segment attribute. The same applies to the historic travel path attribute. Consequently, the road segments and/or the travel paths are described by both historic and current attributes. Consequently, the current attributes can be compared to the corresponding historic attributes. In doing so, amendments in the attributes are comparatively easy to detect.

In an example, the method comprises receiving an external mobility parameter. Such a parameter is received from an external unit and describes at least one aspect of the mobility system. An exemplary external mobility parameter relates to a road closure information or a construction work information which can be provided by a city government. Another exemplary external mobility parameter relates to weather information being provided by an external weather data provider. A further exemplary external mobility parameter can relate to a calendar event being associated to a certain location within the mobility system, e.g. a football match in a football stadium.

An influence of the external mobility parameter on at least one of the road segment attribute or the travel path attribute may be determined and the at least one of the road segment attribute or the travel path attribute may be amended such that the influence of the external mobility parameter is reflected in the corresponding amended road segment attribute or the corresponding amended travel path attribute. Additionally, the at least one of the amended road segment attribute or the amended travel path attribute may be provided to the external entity. It is also possible to derive at least one travel objective parameter from the at least one of the amended road segment attribute or the amended travel path attribute and provide the travel objective parameter to the external entity. Consequently, the external mobility parameter is used to update the representation of the mobility system. In other words, the representation can be extended and enhanced by information resulting from the external mobility parameter. Such information can be helpful to increase the operational efficiency of the mobility system. In an illustrative situation, the external mobility parameter relates to a date and time when a football match ends in a football stadium. Thus, at that time the travel objective parameter will direct participants that are just passing the football stadium along a circumvention road which is not prone to traffic jam.

In a further example, the travel experience parameter received from a specific participant, the resulting influence of the travel experience parameter on at least one of the road segment attribute or the travel path attribute and the amended road segment attribute and the amended travel path attribute may be collected in a participant profile being attributed to the specific participant. Thus, a participant profile is created which comprises information relating to one specific participant. This profile can for example be used in order provide participant-specific or personalized routes through the roadway infrastructure. For example, from the data collected in the participant profile, it may be recognizable that highways are preferred over city roads. Such a preferences can subsequently be utilized when calculating routes.

The method may be at least partly computer-implemented, and may be implemented in software or in hardware, or in software and hardware. Further, the method may be carried out by computer program instructions running on means that provide data processing functions. The data processing means may be a suitable computing means, such as an electronic control module etc., which may also be a distributed computer system. The data processing means or the computer, respectively, may comprise one or more of a processor, a memory, a data interface, or the like.

According to a second aspect, there is provided a data processing device comprising means for carrying out the method of the present disclosure. For example, the data processing device is a centralized data processing device which is superordinate to the participants of the mobility system. Using such a data processing device leads to enhanced operational safety and operational efficiency at system level. This means that the mobility system can be operated at or close to a global optimal as compared to local optimal arms in a scenario where the operation of each single participant is optimized.

The data processing device can be a computer.

According to a third aspect, there is provided a computer-readable medium comprising instructions which, when executed by a computer, cause the computer to carry out the method of the present disclosure. Such a computer-readable medium can be used to improve operational safety and operational efficiency of the mobility system.

According to a fourth aspect, there is provided a system for controlling a mobility system, comprising the data processing device of the present disclosure. Moreover, the system comprises a plurality of participant-level data acquisition devices, each of the participant-level data acquisition devices being attributable to a participant and being configured to generate and provide at least one travel experience parameter to the data processing device of the present disclosure. Alternatively or additionally, the system comprises a plurality of infrastructure-level data acquisition devices being attributable to an element of the roadway infrastructure and being configured to generate and provide at least one infrastructure experience parameter to the data processing device of the present disclosure. Consequently, the mobility system is controlled in a way that operational safety and operational efficiency are enhanced. Furthermore, such a system can control the mobility system in a computationally efficient manner.

If the participant is a vehicle, the participant-level data acquisition device may be locatable inside the vehicle. For example, the participant-level data acquisition device is mountable inside the vehicle.

In case the participant is a pedestrian or a cyclist, the participant-level data acquisition device may just be carried by the participant.

The participant-level data acquisition device is for example a mobile phone or a tablet. It can also be a computer device or a control unit.

It should be noted that the above examples may be combined with each other irrespective of the aspect involved. Accordingly, the method may be combined with structural features and, likewise, the apparatus and the system may be combined with features described above with regard to the method.

These and other aspects of the present disclosure will become apparent from and elucidated with reference to the examples described hereinafter.

### BRIEF DESCRIPTION OF THE DRAWINGS

Examples of the disclosure will be described in the following with reference to the following drawings.

FIG. 1 shows a mobility system and a system for controlling the mobility system in accordance with the present disclosure, the system for controlling the mobility system comprising a data processing device according to the present disclosure having a computer-readable medium according to the present disclosure, wherein the computer-readable medium comprises instructions which cause the data processing device to carry out a method according to the present disclosure,

FIG. 2 shows steps of the method according to the present disclosure,

FIG. 3 shows a representation of the roadway infrastructure in the form of a graph which is stored on the computer-readable medium of FIG. 1,

FIG. 4 illustrates the creation of a user profile for a specific participant of the mobility system of FIG. 1.

The figures are merely schematic representations and serve only to illustrate examples of the disclosure. Identical or equivalent elements are in principle provided with the same reference signs.

### DETAILED DESCRIPTION

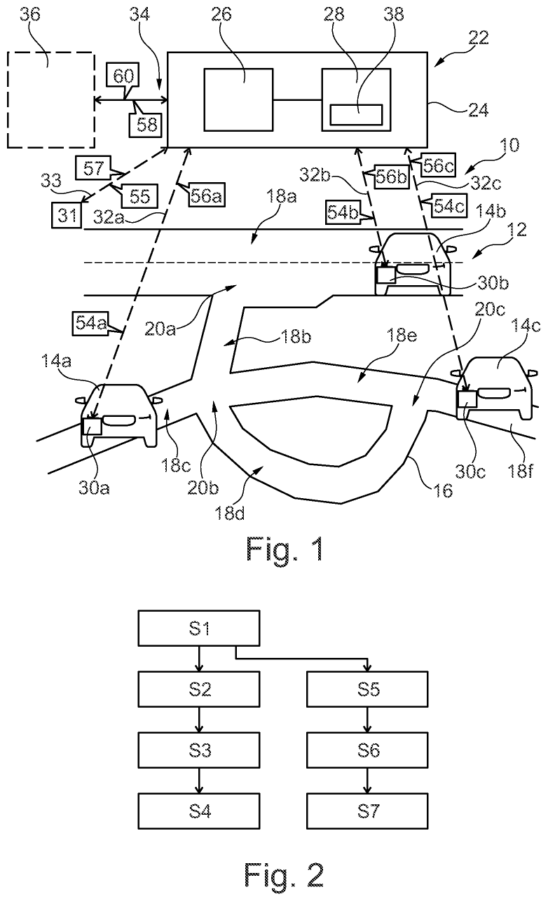

FIG. 1 shows a mobility system 10 comprising a roadway infrastructure 12 and a plurality of participants 14a, 14b, 14c being able to travel within the roadway infrastructure 12.

In the examples illustrated in the Figures, the participants 14a, 14b, 14c are vehicle. It is understood that this is purely illustrative and does not mean that other kinds of participants are excluded. For better understanding, the reference signs 14a, 14b, 14c will also be attributed to these vehicles. As has been explained before, the participants 14a, 14b, 14c are examples of external entities.

For better visibility, the size of the vehicles 14a, 14b, 14c has been artificially increased with respect to the roadway infrastructure 12.

It is understood that the number of three vehicles 14a, 14b, 14c is purely illustrative. It is, of course, possible to have a lot more vehicles traveling within the roadway infrastructure 12.

The roadway infrastructure 12 comprises a network 16 of roads 18a to 18f. These roads 18a to 18f are connected via intersections 20a, 20b, 20c.

in the exemplary roadway infrastructure 12 shown in FIG. 1, road 18a is a highway and the remaining roads 18b to 18f are city roads.

Furthermore, FIG. 1 shows a system 22 for controlling the mobility system 10. The system 22 may therefore also be called a control system.

The system 22 comprises a data processing device 24 having a data processing unit 26 and a data storage unit 28. The data processing unit 26 and the data storage unit 28 are communicatively connected such that data being stored in the data storage unit 28 can be processed by the data processing unit 26. Additionally, data processing results computed in the data processing unit 26 may be stored in the data storage unit 28.

In the present example, the data processing device 24 is a central data processing unit being located on system-level. The data processing device 24 is also an example of a traffic monitoring system. It can be implemented as a cloud service.

The system 22 additionally comprises three participant-level data acquisition devices 30a, 30b, 30c. The participant-level data acquisition device 30a is mounted in vehicle 14a. The participant-level data acquisition device 30b is mounted in vehicle 14b. The participant-level data acquisition device 30c is mounted in vehicle 14c.

Since in the present example, the participants 14a, 14b, 14c are vehicles 14a, 14b, 14c, the participant-level data acquisition devices 30a, 30b, 30c can also be called vehicle-level data acquisition devices 30a, 30b, 30c.

As has already been explained with respect to the vehicles 14a to 14c, also the number of participant-level data acquisition devices 30a to 30c is purely illustrative.

Each of the participant-level data acquisition devices 30a to 30c is communicatively connected to the data processing device 24 via a respective wireless data connection 32a, 32b, 32c. The wireless data connections 32a, 32b, 32c are bidirectional.

The system 22 further comprises an exemplary infrastructure-level data acquisition device 31 being attributable to an element of the roadway infrastructure 12 as will be explained later.

The infrastructure-level data acquisition device 31 is communicatively connected to the data processing device 24 via a respective wireless data connection 33. The wireless data connection 33 is bidirectional.

The infrastructure-level data acquisition device 31 is configured to generate and provide at least one infrastructure experience parameter 55 to the data processing device 24.

The data processing device 24 also comprises an interface 34 to an external unit 36 which will be explained in detail further below. Since the external unit 36 does not form part of the system 22, it is represented in dashed lines.

The data processing device 24 comprises means for carrying out a method for controlling the mobility system 10.

In more detail, the storage unit 28 of the data processing device 24 comprises a computer-readable medium 38 comprising instructions which cause the data processing device 24 to carry out the methods for controlling the mobility system 10 when being executed.

Generally speaking the data processing device 24 can be designated a computer.

The steps of the method for controlling the mobility system 10 are represented in FIG. 2.

In a first step S1, a representation of the roadway infrastructure 12 in the form of a graph 40 is provided.

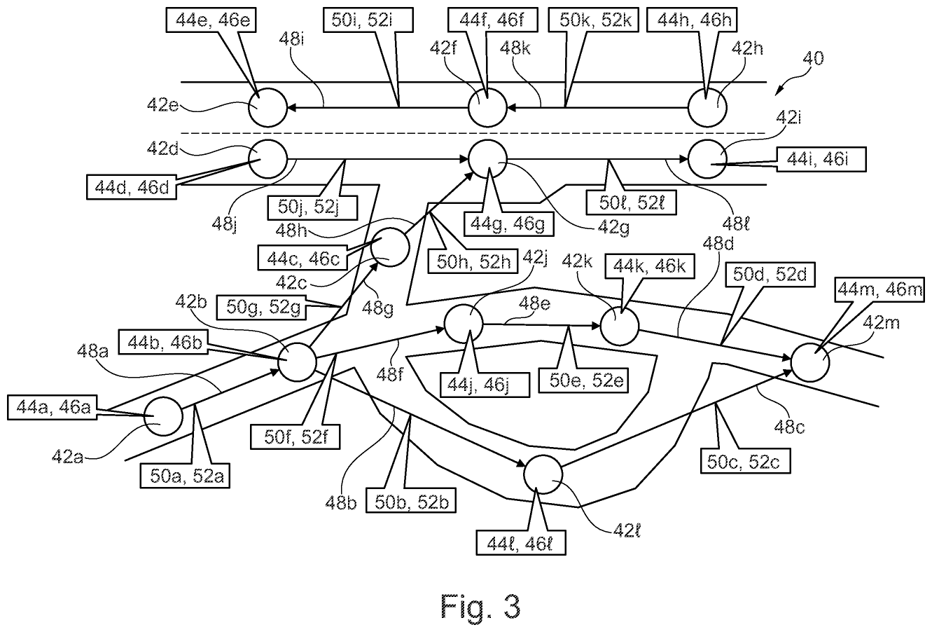

Such a graph 40 is represented in FIG. 3. To facilitate the understanding of the representation performed by the graph 40, the graph 40 is shown as an overlay over the roadway infrastructure 12. For better visibility, the details of the roadway infrastructure 12 are only equipped with reference signs in FIG. 1.

The graph 40 has a plurality of nodes 42a to 42m. Each of the nodes 42a to 42m represents a road segment of the roadway infrastructure 12.

Moreover, each of the road segments is described by an exemplary road segment attribute 44a to 44m and an exemplary historic road segment attribute 46a to 46m being represented as attributes of the corresponding node 42a to 42m.

The graph 40 further has a plurality of edges 48a to 48l, each of the edges 48a to 48l connecting two out of the plurality of nodes 42a to 42m, wherein each of the edges 48a to 48l represents a travel path within the roadway infrastructure 12.

Each of the travel paths is further described by an exemplary travel path attribute 50a to 50l and an exemplary historic travel path attribute 52a to 52l being represented as attributes of the corresponding edges 48a to 48l.

In a second step S2 of the method, exemplary travel experience parameters 54a, 54b, 54c are received from each of the vehicles 14a, 14b, 14c (cf. FIGS. 1 and 2). Alternatively or additionally, the exemplary infrastructure experience parameter 55 is received from the element of the roadway infrastructure 12.

This is done via the corresponding wireless data connection 32a, 32b, 32c, 33.

Each of the travel experience parameters 54a, 54b, 54c is generated by the corresponding participant-level data acquisition device 30a, 30b, 30c. In other words, each of the participant-level data acquisition devices 30a, 30b, 30c is configured to generate and provide at least one travel experience parameters 54a, 54b, 54c to the data processing device 24.

The travel experience parameters 54a, 54b, 54c directly or indirectly describe a travel route within the roadway infrastructure 12 having been traveled by the corresponding vehicle 14a, 14b, 14c or currently being travelled by the vehicle 14a, 14b, 14c.

In a third step S3 of the method for controlling the mobility system 10, an influence of the travel experience parameters 54a, 54b, 54c and/or the infrastructure experience parameter 55 on the road segment attributes 44a to 44m and the travel path attributes 50a to 50l is determined (cf. FIG. 2).

If an influence has been detected, the relevant road segment attributes 44a to 44m and the relevant travel path attributes 50a to 50l are amended such that the influence of the travel experience parameters 54a, 54b, 54c and/or the infrastructure experience parameter 55 is reflected therein.

In other words, the representation in the form of the graph 40 is updated.

Subsequently, in a fourth step S4 (cf. FIG. 2), the amended road segment attributes 44a to 44m and the amended travel path attributes 50a to 50l are provided to the vehicles 14a, 14b, 14c such that the vehicles 14a, 14b, 14c dispose of an updated representation of the roadway infrastructure 12 and can use this representation for making travelling decisions.

Alternatively or additionally, the a travel objective parameter 56a, 56b, 56c for each vehicle 14a, 14b, 14c is derived from the amended road segment attributes 44a to 44m and the amended travel path attributes 50a to 50l. These travel objective parameters 56a, 56b, 56c are provided to the corresponding vehicle 14a, 14b, 14c via the corresponding wireless data connection 32a, 32b, 32c (cf. FIGS. 1 and 2).

It is also possible that an infrastructure objective parameter 57 is derived and provided to the element of the roadway infrastructure 12 being equipped with the infrastructure-level data acquisition device 31.

In order to derive the travel objective parameters 56a, 56b, 56c, and/or the infrastructure objective parameter 57, the road segment attributes 44a to 44m and the travel path attributes 50a to 50l are analyzed jointly.

Optionally, also the historic road segment attributes 46a to 46m and the historic travel path attributes 52a to 52l are considered in the analysis, e.g. as further input parameters.

Analyzing these attributes may comprise the application of a pattern recognition technique, a statistical analysis or a machine learning technique.

Also, in a step S5, the method comprises receiving an external mobility parameter 58 (cf. FIGS. 1 and 2).

The external motility parameter 58 is provided by the external unit 36.

Steps S2 and S5 may be performed in parallel or jointly.

Subsequently, in a step S6, an influence of the external mobility parameter 58 on the road segment attributes 44a to 44m and the travel path attributes 50a to 50l is determined and the road segment attributes 44a to 44m and the travel path attributes 50a to 50l are amended such that the influence of the external mobility parameter 58 is reflected.

Steps S3 and S6 may be performed in parallel or jointly.

Moreover, in a step S7, the amended road segment attributes 44a to 44m and the amended travel path attribute 50a to 50l are provided to the vehicles 14a, 14b, 14c.

This can be done in parallel or jointly to the performance of step S4.

Alternatively or additionally, travel objective parameters 56a, 56b, 56c may be derived from the amended road segment attributes 44a to 44m and the amended travel path attributes 50a to 50l. The travel objective parameters 56a, 56b, 56c are then provided to the respective vehicle 14a, 14b, 14c.

This can also be done jointly with the provision of the travel objective parameters 56a, 56b, 56c being derived from the amended road segment attributes 44a to 44m and the amended travel path attributes 50a to 50l which have been amended due to the experience parameters 54a, 54b, 54c.

Moreover, a travel objective parameter 60 may be provided to the external unit 36. The travel objective parameter 60 may be equal to one of the travel objective parameters 56a, 56b, 56c, however this is not necessarily the case.

In the following, several simplified application scenarios will be explained.

The first application scenario relates to route planning. In more detail, the representation of the roadway infrastructure 12 shall contain information which route the vehicles 14a, 14b, 14c will most probably take. This so-called most probable route can be used for navigating an autonomous vehicle through the roadway infrastructure 12. It is also possible to use the most probable route in a navigation unit of a vehicle being driven by a human driver.

In this application scenario, all travel path attributes 50a to 50l comprise a travel probability parameter. In cases, where more than one edge 48a to 48l originates from a node 42a to 42m, the corresponding travel probability parameter of the travel paths are each inferior to one. This is for example the case for edges 48b, 48f and 48g.

In an initial situation, the travel probability parameter of edge 48b may be 0.6, the travel probability parameter of edge 48f may be 0.2 and the travel probability parameter of edge 48g may be 0.1.

When traveling through the roadway infrastructure 12, each of the vehicles 14a, 14b, 14c generates and provides a travel experience parameter 54a, 54b and 54c. In the present application scenario, the travel experience parameters 54a, 54b and 54c comprises a position parameter. In other words, the travel experience parameters 54a, 54b and 54c comprise an information on which route the respective vehicle 14a, 14b, 14c has taken.

Using again the example of node 42b, the travel experience parameters 54a, 54b, 54c may show that the probability parameters of the edges 48b, 48f and 48g do not correctly reflect the behavior of the vehicles 14a, 14b, 14c.

Consequently, the probability parameters of the edges 48b, 48f and 48g may be updated such that for example, the travel probability parameter of edge 48b may be 0.5, the travel probability parameter of edge 48f may be 0.1 and the travel probability parameter of edge 48g may be 0.4.

A second application scenario relates to a so-called connected cruise control.

In this context, the road segment attributes 44e, 44f and 44h of nodes 42e, 42f and 42h may comprise a traffic flow parameter having the form of a standard speed for traveling these road segments.

Again, each of the vehicles 14a, 14b, 14c generates and provides a travel experience parameter 54a, 54b, 54c. In the present application scenario, the travel experience parameter 54a, 54b, 54c comprises a position parameter and a corresponding travel speed parameter.

Consequently, it is noticeable that the vehicles 14a, 14b, 14c traveling on travel paths being represented by edges 48i and 48k travel at a speed lower than the standard speeds.

Consequently, knowing the number of vehicles 14a, 14b, 14c traveling the road segments being represented by nodes 42e, 42f, 42h, optimal travel speeds can be determined if a security distance in function of the travel speed and the length of the road segments is known.

This optimal travel speed can be provided to each of the vehicles 14a, 14b, 14c in the form of a travel objective parameter 56a, 56b, 56c being a travelling behavior recommendation.

In this application scenario, the flow of vehicles 14a, 14b, 14c is optimized on a system-level.

A third application scenario is about accident risk.

In this application scenario, the road segment attributes 44a to 44m comprise an accident probability parameter.

As before, each of the vehicles 14a, 14b, 14c generates and provides a travel experience parameter 54a, 54b, 54c. In the present application scenario, the travel experience parameter 54a, 54b, 54c comprise a position parameter and a corresponding travel speed parameter.

When analyzing the travel experience parameters 54a, 54b, 54c, e.g. by pattern recognition, it can be found that at least for some of the road segments being represented by nodes 42a to 42m, the accident probability parameter is too low.

Consequently, these road segment attributes 44a to 44m can be updated, wherein the accident probability parameter is increased.

As a further consequence, a travel objective parameter 56a, 56b, 56c comprising a warning message of increased accident risk is provided to each of the vehicles 14a, 14b, 14c. Moreover, a travelling behavior limitation in the form of a speed limit may be provided as a travel objective parameter 56a, 56b, 56c.

A fourth application scenario is about hazard warning.

In this context, the road segment attributes 44a to 44m may comprise a traffic flow parameter having the form of a standard speed for traveling the corresponding road segments.

Again, each of the vehicles 14a, 14b, 14c generates and provides a travel experience parameter 54a, 54b, 54c. In the presence application scenario, the travel experience parameter comprises a position parameter and a corresponding travel speed parameter.

Consequently, it is noticeable that the vehicles 14a, 14b, 14c traveling on a specific road segment, e.g. the one being represented by node 42k, stop travelling.

It can be concluded that a hazard, e.g. an animal or obstacle, is present on the road segment corresponding to this node, e.g. 42k.

As a consequence thereof, a travel objective parameter 56a, 56b, 56c comprising a warning message may be provided to each of the vehicles 14a, 14b, 14c.

Furthermore, vehicles 14a, 14b, 14c traveling on the road segment being represented by node 42j may be instructed to reduce speed.

As a further consequence, the travel path attribute 50f concerning the travel probability of the travel path being represented by edge 48f may be significantly reduced such that vehicles 14a, 14b, 14c circumvent the location of the hazard.

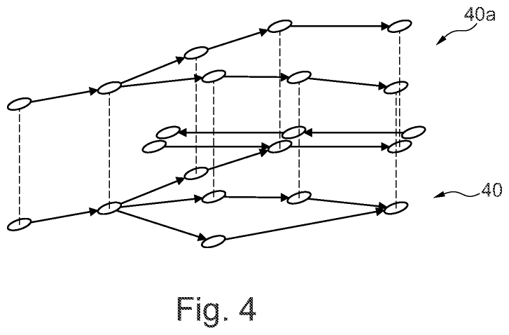

A fifth application scenario is about a participant profile being a vehicle profile in the present example. This is illustrated in FIG. 4.

In this application scenario, the travel experience parameter, e.g. 54a, received from a specific vehicle, e.g. vehicle 14a, is collected in a participant profile being attributed to the specific vehicle.

Moreover, the resulting influence of the travel experience parameter 54a on at least one of the road segment attributes 44a to 44m or the travel path attributes 50a to 50l is stored in a participant profile being attributed to the specific vehicle.

Consequently, graph 40 can be amended using the above-mentioned influences. In doing so, a participant-specific graph 40a is created which is a specific to vehicle 14a.

In FIG. 4, the creation of the participant-specific graph 40a based on graph 40 is schematically illustrated.

A sixth application scenario relates to dynamic mobility regulations. This application scenario is a variant of the second application scenario.

However, in contrast to the second application scenario, now the road segment attribute 44h of node 42h may comprise a traffic regulation parameter having the form of a switching frequency of a traffic light.

Again, each of the vehicles 14a, 14b, 14c generates and provides a travel experience parameter 54a, 54b, 54c. In the present application scenario, the travel experience parameter 54a, 54b, 54c comprises a position parameter and a corresponding travel speed parameter. Thus, it is noticeable that the vehicles 14a, 14b, 14c traveling on travel paths being represented by edges 48i and 48k risk to build up a traffic jam. This is for example noticed by a travel speed having a low average but a high variance, i.e. the vehicles 14a, 14b, 14c brake and accelerate a lot.

Consequently, the switching frequency of the traffic light can be adapted such that smooth traffic flow is guaranteed on the travel paths being represented by edges 48i and 48k.

In a variant of the sixth application scenario also the infrastructure experience parameter 55 is used. In the present application scenario the corresponding element of the roadway infrastructure is a ticketing system of a football stadium, more precisely the ticketing system of a parking lot of the football stadium. When analyzing the infrastructure experience parameter 55 it is noticeable that a lot of vehicles are leaving the parking lot. Thus, the switching frequency of the traffic light can also take into account this circumstance and guarantee smooth traffic.

A seventh application scenario relates to dynamic speed control.

Now the road segment attribute 44f of node 42f may comprise a traffic regulation parameter having the form of a deployment height of a deployable speed bump.

Again, each of the vehicles 14a, 14b, 14c generates and provides a travel experience parameter 54a, 54b, 54c. In the present application scenario, the travel experience parameter 54a, 54b, 54c comprises a position parameter and a corresponding travel speed parameter. Thus, it is noticeable that the vehicles 14a, 14b, 14c exceed the speed limit by far when using the travel paths being represented by edges 48i and 48k.

Consequently, the deployment height of the deployable speed bump can be increased such that the vehicles 14a, 14b, 14c need to reduce the corresponding travel speed.

Other variations to the disclosed examples can be understood and effected by those skilled in the art in practicing the claimed disclosure, from the study of the drawings, the disclosure, and the appended claims. In the claims the word “comprising” does not exclude other elements or steps and the indefinite article “a” or “an” does not exclude a plurality. A single processor or other unit may fulfill the functions of several items or steps recited in the claims. The mere fact that certain measures are recited in mutually different dependent claims does not indicate that a combination of these measures cannot be used to advantage. A computer program may be stored/distributed on a suitable medium such as an optical storage medium or a solid-state medium supplied together with or as part of other hardware, but may also be distributed in other forms, such as via the Internet or other wired or wireless telecommunication systems. Any reference signs in the claims should not be construed as limiting the scope of the claims.

### LIST OF REFERENCE SIGNS

10 mobility system
12 roadway infrastructure
14a-14c participant, vehicle
16 network
18a-18f road
20a, 20b, 20c intersection
22 system for controlling a mobility system
24 data processing device
26 data processing unit
28 data storage unit
30a, 30b, 30c participant-level data acquisition device
31 infrastructure-level data acquisition device
32a, 32b, 32c wireless data connection
33 wireless data connection
34 interface
36 external unit
38 computer-readable medium
40 graph
40a participant-specific graph
42-42m node
44a-44m road segment attribute
46a-46m historic road segment attribute
48a-48l edge
50a-50l travel path attribute
52a-52l historic travel path attribute
54a, 54b, 54c travel experience parameter
55 infrastructure experience parameter
56a, 56b, 56c travel objective parameter
57 infrastructure objective parameter
58 external mobility parameter
60 travel objective parameter
S1 method step
S2 method step
S3 method step
S4 method step
S5 method step
S6 method step
S7 method step

1. A method for controlling a mobility system, the mobility system comprising a roadway infrastructure and a plurality of participants being able to travel within the roadway infrastructure, the method comprising:
providing a representation of the roadway infrastructure in the form of a graph having a plurality of nodes and a plurality of edges, each of the edges connecting two out of the plurality of nodes, wherein each of the nodes represents a road segment of the roadway infrastructure and each of the edges represents a travel path, and wherein each of the road segments is described by at least one road segment attribute of the corresponding node or each of the travel paths is described by at least one travel path attribute of the corresponding edge,
receiving at least one travel experience parameter from at least one of the plurality of participants, the travel experience parameter describing directly or indirectly a travel route within the roadway infrastructure having been traveled by the participant or currently being travelled by the participant or receiving at least one infrastructure experience parameter from an element of the roadway infrastructure, and
determining an influence of the travel experience parameter or the infrastructure experience parameter on at least one of the road segment attribute or the travel path attribute and amending the at least one of the road segment attribute or the travel path attribute such that the influence of the at least one travel experience parameter or the infrastructure experience parameter is reflected in at least one of an amended road segment attribute or an amended travel path attribute.

2. The method according to claim 1, comprising:
providing the at least one of the amended road segment attribute or the amended travel path attribute to an external entity or deriving at least one travel objective parameter from the at least one of the amended road segment attribute or the amended travel path attribute and providing the travel objective parameter to the external entity.

3. The method according to claim 2, wherein the external entity is at least one of a traffic monitoring system, at least one of the plurality of participants, a cloud service or an external unit.

4. The method according to claim 2, wherein providing the travel objective parameter comprises applying at least one of a pattern recognition technique, a statistical analysis or a machine learning technique to at least one of the amended road segment attribute or the amended travel path attribute.

5. The method according to claim 2, wherein the travel objective parameter comprises at least one of a warning message, a travelling behavior recommendation, a travelling behavior instruction or a travelling behavior limitation.

6. The method according to claim 1, wherein the road segment attribute or the amended road segment attribute each comprise at least one of an identification parameter, a location parameter, a road class parameter, a road geometry parameter, a road friction parameter, a traffic flow parameter, a traffic regulation parameter, an accident probability parameter or a hazard probability parameter.

7. The method according to claim 1, wherein the travel path attribute or the amended travel path attribute each comprise at least one of an identification parameter, a neighbor description parameter, a travel probability parameter or an intersection angle parameter.

8. The method according to claim 1, wherein the travel experience parameter comprises at least one of a position parameter or a travel speed parameter.

9. The method according to claim 1, wherein
at least one of the road segments is described by at least one historic road segment attribute or at least one of the travel paths is described by at least one historic travel path attribute.

10. The method according to claim 1, comprising:
receiving an external mobility parameter.

11. The method according to claim 10, comprising:
determining an influence of the external mobility parameter on at least one of the road segment attribute or the travel path attribute and amending the at least one of the road segment attribute or the travel path attribute such that the influence of the external mobility parameter is reflected in the corresponding amended road segment attribute or the corresponding amended travel path attribute, and
providing the at least one of the amended road segment attribute or the amended travel path attribute to the external entity or deriving at least one travel objective parameter from the at least one of the amended road segment attribute or the amended travel path attribute and providing the travel objective parameter to the external entity.

12. The method according to claim 1, comprising:
collecting the travel experience parameter received from a specific participant, the resulting influence of the travel experience parameter on at least one of the road segment attribute or the travel path attribute or the amended road segment attribute or the amended travel path attribute in a participant profile being attributed to the specific participant.

13. A data processing device comprising:
means for carrying out the method for controlling a mobility system, the mobility system comprising a roadway infrastructure and a plurality of participants being able to travel within the roadway infrastructure, the method comprising:
providing a representation of the roadway infrastructure in the form of a graph having a plurality of nodes and a plurality of edges, each of the edges connecting two out of the plurality of nodes, wherein each of the nodes represents a road segment of the roadway infrastructure and each of the edges represents a travel path, and wherein each of the road segments is described by at least one road segment attribute of the corresponding node and each of the travel paths is described by at least one travel path attribute of the corresponding edge,
receiving at least one travel experience parameter from at least one of the plurality of participants, the travel experience parameter describing directly or indirectly a travel route within the roadway infrastructure having been traveled by the participant or currently being travelled by the participant or receiving at least one infrastructure experience parameter from an element of the roadway infrastructure, and
determining an influence of the travel experience parameter or the infrastructure experience parameter on at least one of the road segment attribute or the travel path attribute and amending the at least one of the road segment attribute or the travel path attribute such that the influence of the at least one travel experience parameter or the infrastructure experience parameter is reflected in at least one of an amended road segment attribute or an amended travel path attribute.

14. A computer-readable medium comprising instructions which, when executed by a computer, cause the computer to carry out the method for controlling a mobility system, the mobility system comprising a roadway infrastructure and a plurality of participants being able to travel within the roadway infrastructure, the method comprising:
providing a representation of the roadway infrastructure in the form of a graph having a plurality of nodes and a plurality of edges, each of the edges connecting two out of the plurality of nodes, wherein each of the nodes represents a road segment of the roadway infrastructure and each of the edges represents a travel path, and wherein each of the road segments is described by at least one road segment attribute of the corresponding node or each of the travel paths is described by at least one travel path attribute of the corresponding edge,
receiving at least one travel experience parameter from at least one of the plurality of participants, the travel experience parameter describing directly or indirectly a travel route within the roadway infrastructure having been traveled by the participant or currently being travelled by the participant or receiving at least one infrastructure experience parameter from an element of the roadway infrastructure, and
determining an influence of the travel experience parameter or the infrastructure experience parameter on at least one of the road segment attribute or the travel path attribute and amending the at least one of the road segment attribute or the travel path attribute such that the influence of the at least one travel experience parameter or the infrastructure experience parameter is reflected in at least one of an amended road segment attribute or an amended travel path attribute.

15. A system for controlling a mobility system, comprising:
a data processing device comprising:
means for carrying out the method for controlling a mobility system, the mobility system comprising a roadway infrastructure and a plurality of participants being able to travel within the roadway infrastructure, the method comprising:
providing a representation of the roadway infrastructure in the form of a graph having a plurality of nodes and a plurality of edges, each of the edges connecting two out of the plurality of nodes, wherein each of the nodes represents a road segment of the roadway infrastructure and each of the edges represents a travel path, and wherein each of the road segments is described by at least one road segment attribute of the corresponding node or each of the travel paths is described by at least one travel path attribute of the corresponding edge,
receiving at least one travel experience parameter from at least one of the plurality of participants, the travel experience parameter describing directly or indirectly a travel route within the roadway infrastructure having been traveled by the participant or currently being travelled by the participant or receiving at least one infrastructure experience parameter from an element of the roadway infrastructure, and
determining an influence of the travel experience parameter or the infrastructure experience parameter on at least one of the road segment attribute or the travel path attribute and amending the at least one of the road segment attribute or the travel path attribute such that the influence of the at least one travel experience parameter or the infrastructure experience parameter is reflected in at least one of an amended road segment attribute or an amended travel path attribute,
a plurality of participant-level data acquisition devices, each of the participant-level data acquisition devices being attributable to a participant and being configured to generate and provide at least one travel experience parameter to the data processing device or a plurality of infrastructure-level data acquisition devices being attributable to an element of the roadway infrastructure and being configured to generate and provide at least one infrastructure experience parameter to the data processing device.
